(19) United States
(12) Patent Application Publication
(10) Pub. No.: US 2015/0107746 A1
(43) Pub. Date: Apr. 23, 2015

(54) TIRE APEX STRUCTURE

(71) Applicant: E I DU PONT DE NEMOURS AND COMPANY, Wilmington, DE (US)

(72) Inventor: MARK ALLAN LAMONTIA, Landenberg, PA (US)

(21) Appl. No.: 14/516,605

(22) Filed: Oct. 17, 2014

Related U.S. Application Data
(60) Provisional application No. 61/892,563, filed on Oct. 18, 2013.

(51) Int. Cl. B60C 15/06; B29C 47/00; B29D 30/48; B29C 43/24; B60C 9/00; B29D 30/32

(52) U.S. Cl. CPC B60C 15/0603; B60C 9/0042; B29D 30/32; B29D 30/48; B29C 43/24; B29C 47/0021; B29D 2030/481; B29K 2009/00
USPC 152/541; 156/131

(57) ABSTRACT

A vehicle tire having an apex component that is made of a plurality of elastomeric strips containing reinforcement fibers that are aligned substantially parallel to each other in a controlled angle of orientation within the strip wherein the orientation is selected such that it increases the stiffness of the apex component.

### BACKGROUND OF THE INVENTION

1. Field of the Invention

This invention is directed to structure and composition of the tire apex component.

2. Description of the Related Art

Some tire performance attributes include handling and braking. These attributes are influenced by the presence of sidewall components such as apexes, chippers, and flippers as disclosed in US Patent Publication 2010/0108220 to Mruk et al (hereafter, Mruk). As is known in the art, the apex is a wedge-shaped component used to stiffen the sidewall and is located near the bead portion of a tire. Mruk teaches that short fibers with a specific orientation can be incorporated into the apex, chipper, and flipper of a tire as reinforcement.

### BRIEF DESCRIPTION OF THE DRAWINGS

FIG. 1 shows selected components of a conventional prior art vehicle tire.

FIG. 2 shows an embodiment of the apex area in the vehicle tire sidewall.

FIGS. 3A-3D depict arrangements of reinforcement fibers embedded within the apex area strips.

### DETAILED DESCRIPTION OF THE INVENTION

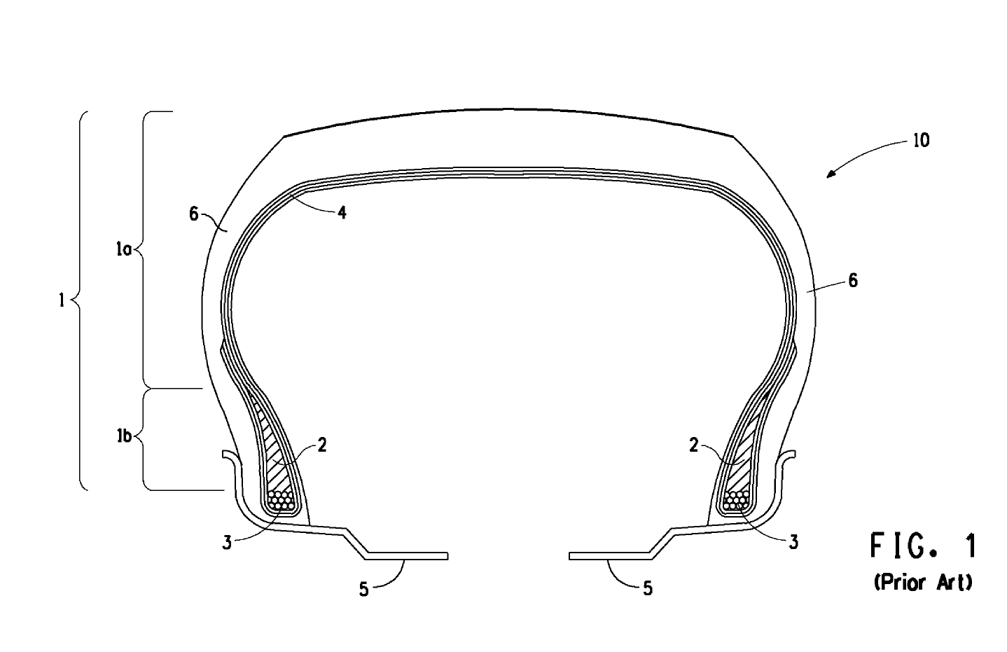

There is a continued need for improved vehicle tire performance; and improvement to handling can be achieved by stiffening the sidewall. Shown generally at 10 in FIG. 1 is a cross-section of a generic prior art vehicle tire having plies 4 and carcass body 6 mounted on a rim 5, with sidewall 1. Sidewall 1 is further described as an upper section 1a and a lower section 1b. Beads 3 are located where the tire sits on the rim 5. “Bead” means that part of the tire comprising an annular tensile member wrapped by ply cords 4 and shaped, with or without, other reinforcement elements. Tire apex 2, shown in the lower sidewall section 1b, is conventionally a triangular-shaped elastomeric material extruded profile that mates against the bead and provides a cushion between the rigid bead 3 and the flexible inner liner and body ply, both designated 4 for the sake of convenience.

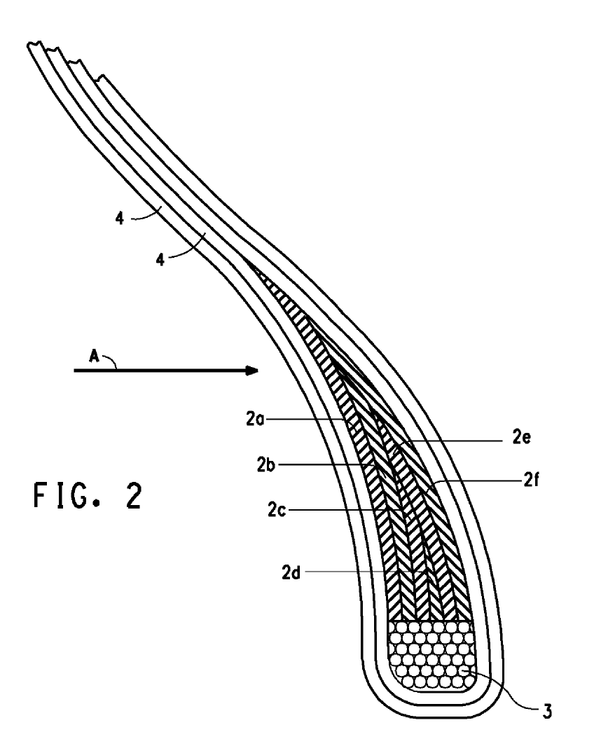

This invention is directed to an automobile tire comprising an apex component and a bead component and wherein the apex component comprises a plurality of elastomeric strips with embedded reinforcement fibers. Regarding this invention, attention is directed to the apex section of sidewall 1b and is shown in further detail in FIG. 2. Apex 2 is depicted as comprising six strips 2a-2f, although six is not intended to be a limiting value, that is, the number of strips could be lower or higher than six, but allowance must be made for calendered strips of some thickness. Forming the apex shape is best done with a relatively large number of unequal length strips. In one embodiment, the number of strips would be the apex width dimension divided by the strip thickness.

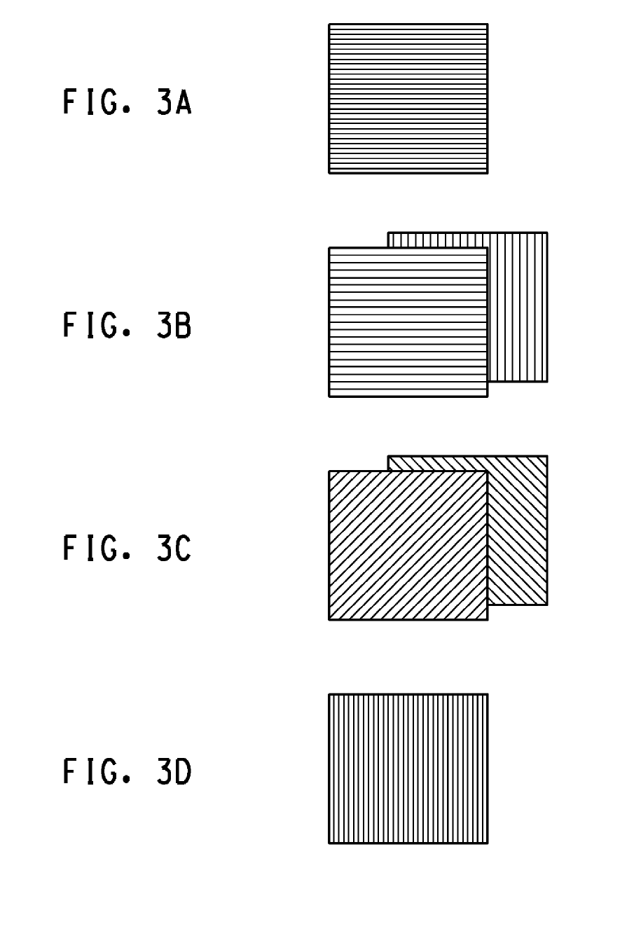

As shown in FIG. 2, the strips are positioned such that the bottom edge surfaces are in contact with the bead component 3. The upper edge surface of a strip is in contact with the upper edge surface of an adjacent strip or is in contact with an adjacent ply. The top edge surface of a strip may be chamfered, but is not essential because the strip will be formed into a chamfered shape as the rubber compound flows during tire processing and curing. It should be noted that the strips as depicted in FIG. 2 are after curing, whereas the ends would be squared off before curing. It should be further noted that the cross-hatching of strips 2a-2f in FIG. 2 is provided merely to easily delineate the individual strips and is not intended to represent fiber orientation. The reinforcement fibers are embedded in the strips and are aligned substantially parallel to each other in a controlled angle of orientation within the strip wherein the orientation is selected such that it increases the stiffness of the apex component. FURTHER, TO DESCRIBE THE FIBER ORIENTATION WHEN THE TIRE IS IN MOTION, THE MAJOR PORTION OF THE REINFORCEMENT FIBERS ARE ORIENTED IN A PLANE SUBSTANTIALLY PARALLEL TO OR ORTHOGONAL TO THE ROAD CONTACT SURFACE IN ONE OR MORE STRIPS. Various orientations of the reinforcement fibers as embedded in the strips are presented in FIGS. 3A-3D as would be viewed perpendicular to the sidewall as depicted by arrow A in FIG. 2. Note that FIGS. 3A and 3D show only one strip which would indicate that all of the strips have the same orientation, that is circumferential and meridional, respectively. However, FIGS. 3B and 3C indicate adjacent strips having different orientations and are presented only for illustrative purposes and is not intended to be limiting in any manner. The fiber orientations expressed in degrees are shown in FIGS. 3A-3D as 0°; 0° and 90°; +45° and −45° and 90°, respectively. Although FIG. 3C depicts orientations at +45° and −45 other sets of acute angles L can be used that are greater than 0° and less than 90°, for example +30° and −30° or +60° and −60°.

For improvement in handling, at least two strips would have the fiber reinforcement oriented in the meridional direction, that is, along the tire carcass and in the same direction as the carcass ply (FIG. 3D). The meridional is similar to the radial direction; but unlike the radial direction it does not represent a straight line direction, but rather is curvilinear as depicted by the strips 2a -2f in FIG. 2. This structure improves handling by stiffening the tire to inhibit the carcass from over-rotating sideways.

For improvement in braking, the reinforcement fibers would preferably be bias oriented. In other words, viewing the tire construction from the sidewall in FIG. 2, the orientation would be +45° and −45° as depicted in FIG. 3C. In a preferred embodiment for braking, there would be an even number of strips. It should be understood that under both acceleration and braking, tires are subject to the same type of forces, but in opposite directions, so hereafter the term “braking” will be used to encompass both.

For improvement of both handling and braking in a tire, various combinations of reinforced strips can be used. In an embodiment having six strips that make up the apex as depicted in FIG. 2, the outermost strip 2a (closer to the tire sidewall) and the innermost strip 2f (closer to the interior of the tire) can be made with meridional reinforcement fibers for handling, while middle strips 2b-2e can be made with bias reinforcement fibers for braking. In general terms, for improvement of both handling and braking, an even number of strips with bias reinforcement fibers would be in the middle, that is the outermost and innermost strips would have meridional reinforcement fibers for handling. There are other possible embodiments, for example, outermost strip 2a and innermost strip 2f with meridional reinforcement fibers for handling and middle strips 2b through 2e made of conventional rubber compounds (that is, without fiber reinforcement) for braking. An alternative would have outermost strip 2a and innermost strip 2f, both with bias reinforcement for braking and middle strips 2b-2e made of conventional rubber compound (without reinforcement fibers) for handling.

In some cases when the outermost strip and innermost strip have a particular orientation of reinforcement fibers, the remaining middle strips can have meridional reinforcement, bias reinforcement or conventional rubber compound without reinforcement fibers. It should be further noted that if there were meridional and bias reinforcement in the same apex, then the strips with meridional reinforcement would be outermost and the strips with bias reinforcement would be innermost. As noted above with reference to FIG. 2, strip 2a would be the outermost and strip 2f would be innermost and the other middle strips would be designated based on whether they were closer to 2a or 2f.

The cured elastomers comprising the strips can be natural rubber, styrene butadiene rubber, butadiene rubber and mixtures thereof. The reinforcement fibers can be continuous or discontinuous and made from the non-limiting group of aromatic polyamides, aliphatic polyamides, polyesters, polyolefins, polyazoles, carbon, rayon, glass, and mixtures thereof. A suitable aromatic polyamide is p-aramid, such as Kevlar® available from E.I. du Pont de Nemours and Company, Wilmington Del. (DuPont). Another suitable reinforcement material is Kevlar® Engineered Elastomer, also available from DuPont.

The subject invention is also directed to a method of for increasing the stiffness of an apex component of a tire by:

(a) identifying a mechanism to increase the stiffness of an apex component;
(b) providing an apex compound of strips that extend substantially in the same direction as the carcass plies;
(c) introducing into the apex compound reinforcing fibers having an orientation that is adapted to increase the stiffness of the apex component based on the mechanism identified in step (a).

A process for producing a tire comprising a composite apex component, includes providing a cured elastomer; and introducing reinforcement fiber into the cured elastomer of from 0.1 to 10 parts per hundred parts by weight of the elastomer and fibers. The fibers have a tenacity of at least 6 grams per dtex and a modulus of at least 200 grams per dtex and a major portion of the fibers are oriented in a plane substantially parallel to or orthogonal to the road contact surface in one or more strips. The process comprises the steps of

(a) compounding in a high shear mixer, roll mill or extruder an uncured elastomer comprising short fiber, elastomer and other additives,
(b) calendering or extruding the uncured elastomer into one or more strips having a profile in which the fibers are aligned in the desired direction,
(c) assembling the first stage components of a tire assembly, including the bead and apex strips, in sequence on a drum,
(d) assembling the second stage components of a tire assembly in sequence on a bladder press tool, and
(e) placing the tire assembly in a mold and curing the elastomeric compounds by heat and pressure.

What is claimed is:

1. An automobile tire comprising an apex component and a bead component, the apex component further comprising a plurality of elastomeric strips where one of the strips is outermost and one of the strips is innermost containing reinforcement fibers with each strip having a top face surface, a bottom face surface, a top edge surface and a bottom edge surface, wherein
(i) the strips are positioned such that the bottom edge surfaces are in contact with the bead component;
(ii) the top edge surface of a strip is in contact with the top face surface of an adjacent strip or an adjacent ply,
(iii) the reinforcement fibers in the strip are aligned substantially parallel to each other in a controlled angle of orientation within the strip wherein the orientation is selected such that it increases the stiffness of the apex component.

2. The tire of claim 1, wherein the reinforcement fibers are aligned in a meridional direction.

3. The tire of claim 1, wherein the reinforcement fibers are aligned in a bias direction at (+) acute angle L and (−) acute angle L, wherein L is greater than 0° and less than 90°.

4. The tire of claim 3, wherein the reinforcement fibers are aligned in a bias direction at +45° and −45°.

5. The tire of claim 1, wherein the reinforcement fibers are aligned in a circumferential direction.

6. The tire of claim 1, wherein the reinforcement fibers are aligned in a meridional direction in one strip and a bias direction in a different strip.

7. The tire of claim 1, wherein the outermost strip and the innermost strip have meridional fiber reinforcement and the middle strips have bias fiber reinforcement.

8. The tire of claim 7, wherein the middle strips do not have any reinforcement fibers.

9. the tire of claim 1, wherein the outermost strips have bias reinforcement fibers and the innermost strips have meridional reinforcement fibers.

10. The tire of claim 1, wherein the outermost strip and the innermost strip have bias fiber reinforcement and the middle strips do not have any fiber reinforcement.

11. The tire of claim 1, wherein the outermost strip and the innermost strip have meridional fiber reinforcement and the middle strips have bias fiber reinforcement.

12. The tire of claim 1, wherein the fibers are selected from the group consisting of aromatic polyamides, aliphatic polyamides, polyesters, polyolefins, polyazoles, carbon, rayon, glass, and mixtures thereof.

13. The tire of claim 12, wherein the fibers are continuous or discontinuous.

14. The tire of claim 1, wherein said cured elastomer is selected from the group consisting of natural rubber, styrene butadiene rubber, butadiene rubber and mixtures thereof.

15. The tire of claim 11, wherein aromatic polyamide is para-aramid.

16. A method for increasing the stiffness of an apex component of a tire comprising the steps of.
(a) identifying a mechanism to increase the stiffness of an apex component;
(b) providing an apex compound;
(c) introducing into the apex compound reinforcing fibers with an orientation that is adapted to increase the stiffness of the apex component based on the identified mechanism in step (a).

17. A process for producing a tire comprising a composite apex component, the composite further comprising:
a cured elastomer; and
from 0.1 to 10 parts per hundred parts by weight of said elastomer of fibers; said fibers being characterized as having a tenacity of at least 6 grams per dtex and a modulus of at least 200 grams per dtex,
wherein a major portion of said fibers are oriented in a plane substantially parallel to or orthogonal to the road contact surface in one or more strips; said process comprising the steps of
(a) compounding in a high shear mixer, roll mill or extruder an uncured elastomer comprising short fiber, elastomer and other additives,
(b) calendering or extruding said uncured elastomer into one or more strips having a profile in which the fibers are aligned in the desired direction,
(c) assembling the first stage components of a tire assembly, including the bead and apex strips, in sequence on a drum,
(d) assembling the second stage components of a tire assembly in sequence on a bladder press tool, and
(e) placing the tire assembly in a mold and curing the elastomeric compounds by heat and pressure.

18. The process of claim 17, comprising consolidating a plurality of the strips.
